(19) United States
(12) Patent Application Publication
(10) Pub. No.: US 2014/0249879 A1
(43) Pub. Date: Sep. 4, 2014

(54) NETWORK SYSTEM AND METHOD

(71) Applicant: Mark Oleynik, London (GB)

(72) Inventor: Mark Oleynik, London (GB)

(21) Appl. No.: 14/235,557

(22) PCT Filed: Jul. 30, 2012
(86) PCT No.: PCT/GB2012/051843

§ 371 Date: Apr. 24, 2014

(30) Foreign Application Priority Data
Jul. 29, 2011 (GB) 1113123.2

(51) Int. Cl. G06Q 50/00; G06Q 20/34; G06Q 10/10

(52) U.S. Cl. CPC G06Q 50/01; G06Q 10/1095; G06Q 20/34
USPC 705/7.19; 705/319; 705/35

(57) ABSTRACT

The present invention concerns a system and method configured for hosting a network for facilitating interaction between members of certain socioeconomic and/or interest groups. The system comprises a categorizing module for categorizing individuals according to certain criteria to form a plurality of groups of members, wherein admittance to each group is regulated based on an authority specializing in the specific characteristic of that group, a governing module for establishing a set of rules governing from which groups members are authorized to interact with one other, and an administrator module for administrating said rules, the administrator governing connectivity between members in said groups.

The present invention relates to a selective network system and method for facilitating the interaction of certain individuals.

In this respect, the rise of internet dating agencies and social networks such as FACEBOOK (Trade Mark) has indicated that a growing proportion of the public are looking to such networks to provide a means for promoting social interaction.

However, to date, networks such as FACEBOOK (Trade Mark) suffer enormously from confidentiality issues, with outsiders taking personal information inappropriately or with members themselves misrepresenting themselves in one way or another to others. For this reason, FACEBOOK (Trade Mark) is avoided by many discerning individuals.

There are also many Internet dating agencies which offer greater security and confidentially. However, such agencies suffer from being specifically designed purely for assisting in connecting individuals for the purpose of starting a relationship.

The present invention seeks to provide a novel and inventive network system and method that seeks to overcome the problems and shortfalls associated with the above.

According to the present invention there is provided a system configured for hosting a network for facilitating interaction between members of certain socioeconomic and/or interest groups; the system comprising: a categorising module for categorising individuals according to certain criteria to form a plurality of groups of members, wherein admittance to each group is regulated based on an authority specialising in the characteristic of that group; a governing module for establishing a set of rules governing from which groups, members are authorised to interact with one other; and an administrator module for administrating said rules; said administrator module governing connectivity between members in said groups. In this regard, the system provides for controlled connectivity between certain group members.

Preferably, a first one of said groups is based on its member's financial standing, this criteria being regulated through a recognised financial institution.

Conveniently, a second one of said groups is based on physical appearance, this criteria being regulated through a recognised modelling agency.

A third one of said groups may be based on an interest in a consumer article, this criteria being regulated through a recognised specialist in that article. Preferably, the article concerned is a horological instruments.

In a preferred embodiment, the network system further comprises an event module accessible to members for proposing future events to other members, such events being made available only to certain members according to said set of rules.

The network system may further comprise a profile module for compiling and storing a profile of each member. The network may monitor a member's event proposals and forwarding details of such an event proposal to other members who have both a potential common interest from their profile and who are authorised to have connectivity with said member proposing the event.

Indeed, the network system may further comprise a commerce platform module for facilitating sale of goods of common interest between members having authorised connectivity.

Preferably, the network system further comprises a support module, said support module comprising a plurality of service providers on stand by for dealing with specific issues raised by said administrator module on behalf of said members.

According to a further aspect of the present invention there is provided a computer-implemented method for providing a network for facilitating interaction between members of certain socioeconomic and/or interest groups; the method comprising: categorising individuals according to certain criteria to form a plurality of groups of members; establishing a set of rules governing from which groups members are authorised to interact with one other; wherein admittance to each group is regulated based on an authority specialising in the characteristic of that group; and administrating said rules to govern connectivity between members in said groups.

Preferably, a first one of said groups categorised based on its member's financial standing, this criteria being regulated through a recognised financial institution.

Conveniently, a second one of said groups is categorised on physical appearance, this criteria being regulated through a recognised modelling agency.

Further, a third one of said groups may be categorised on an interest in a consumer article, this criteria being regulated through a recognised specialist in that article.

Preferably, the network or method is set up to operate on the Internet.

The present invention further encompasses a computer program for carrying out the network or method described above.

Conveniently, obtaining access to the system or network is via a secure identity verification process, involving one or more of finger print analysis, retinal scanning, voice recognition, signature and password submission.

Preferably, finger print analysis is carried out according to one or more designated digit prompts. For example the member will be asked to provide a 1^{st} finger and 5^{th} finger print for analysis.

Examples of the present invention will now be described with reference to the drawings, of which:—

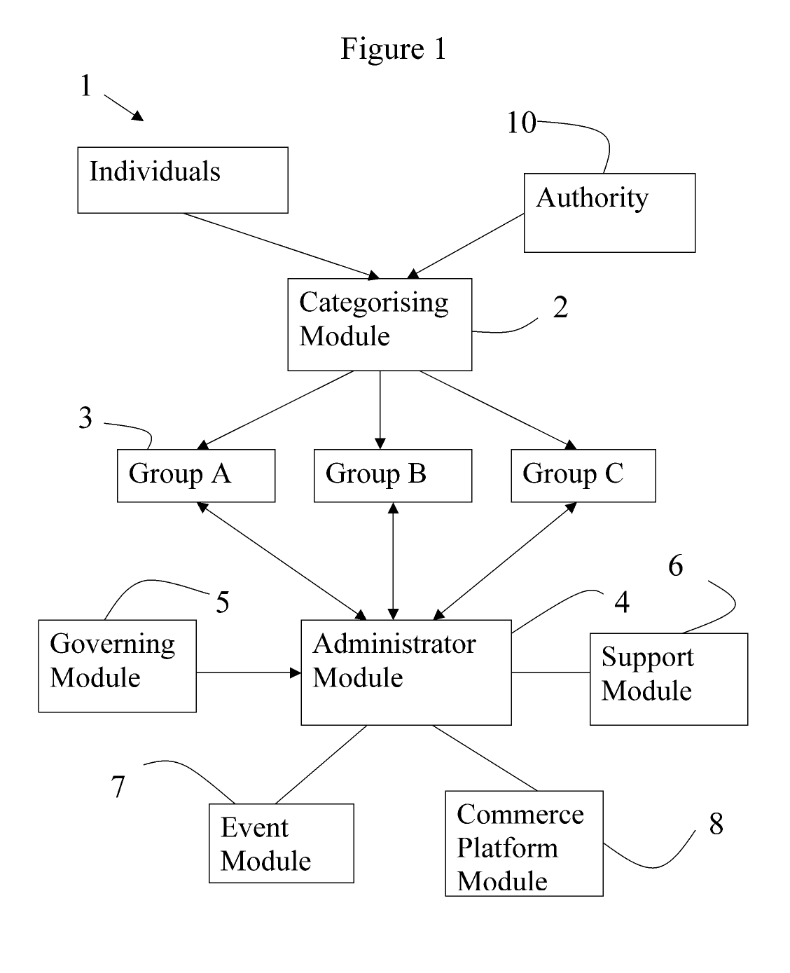

FIG. 1 shows a schematic drawing of a network according to the present invention.

If one considers the general public as a whole it will be appreciated that people are divided into certain social groups or societies.

The “membership” profile for each of these groups relates to many factors, including their background and their interests, and factors such as wealth and appearance clearly play their part.

Indeed, factors defining how such social environments are formed will include: wealth (further grading is based on the extent of wealth), sexual orientation (i.e. heterosexual, homosexual, lesbian), perceived beauty, celebrity status, sports such as angling, illnesses such as diabetes, interest in the arts, gourmets, specific article interests (e.g. time-pieces, pictures, stamps, cars, air planes), lovers of night life, music, fun seekers, surf-riders. Clearly this list is illustrative rather than exhaustive.

Clearly, there are certain social groups which have traditionally sought socialisation with one another. For example, wealthy, famous and beautiful people tend to mix together.

However, at the present time, such relationships are not based on any particular or definite system and are haphazard in nature.

More specifically, interaction between such groups are often down to random and chance meetings and connections. The individuals of one social group or environment may for example become acquainted via friends or acquaintances in clubs and social events. This can be somewhat restrictive due to the limited choice of individuals and, all too often, the inability to visually identify the representative of a particular social group solely on certain criteria of appearance.

Existing social networks such as FACEBOOK (Trade Mark) are in this respect directed to expanding an individual's circle of contacts. However they are characterised by a number of disadvantages:

1. Lack of confidentiality. Access is usually protected only by a login and a password and there are numerous instances of breaking into such social media sites by interested parties and use of the obtained information for illegitimate purposes. Furthermore, the liability of the owners, management and moderators of the open social network for unauthorised use of such information is not fully clear. The users of the social network are also not generally bound by a confidentiality policy.

2. Low reliability. Members can have a virtual/fictitious image, consisting of a name, a surname or a nickname of their own choosing. All too often, the photos are false, i.e. of other people, or the photos do not reflect the member's current appearance. Moreover physical parameters are not indicated or are false. As such, the level of credibility of people on such social networks to one another is fairly low.

3. The structuring of members is based on excessively wide principles (place of work, place of study, holiday destination, location, etc.), which do not mostly correspond to the individual interests of the member, which, as a result wastes a great deal of time in the search for individuals of interest. Often more time is wasted in communicating with people who have knowingly misrepresented information about themselves to increase their competitiveness or attractiveness.

4. Lack of communication between virtual and real world. As discussed above, existing social networks can be devoid of real world reality, and there is little or no opportunity for the arrangement of associated services (buying/selling of goods and services, which might be of interest for certain groups of social environment, direct trading between members) in a time saving mode.

In order to try to alleviate some of the issues illustrated above, there is provided in the present invention, as shown in FIG. 1, a network 1, where individuals are initially categorised by a categorising module 2 into groups 3 according to certain criteria.

One of these is for example personal financial standing, another perhaps being appearance and a further possibly celebrity status. An authority 10 for each type of group is used, for example a recognised bank for financial standing.

Members within these groups will have their own interests such as the arts, recreation, sport, fine dining, cars, watches etc.

These groups are organized, by an administrator module 4 such that there are rules set by a governing module 5 governing whether members of one group may make contact with members of the same or another group. Communication is administrated by the administrator module 4 which regulates the connectivity between members in the groups.

A support module 6 may be provided in order to deal with any issues/requests from members. The support module will hold a directory of specialist service provider on standby so that in essence whatever problem is raised, there will be someone who can provide a solution.

An events calender/diary module 7 may be provided enabling members to post events or request the administrator to set up events as discussed below in accordance with their connectivity.

Further a commercial platform module 8 allows members to engage in commercial activities, again as discussed below, in accordance with their connectivity.

The present invention therefore seeks to unite the individuals of social environments in a closed protected and confidential social network, providing for a high level of assurance that the members are indeed genuine members. The present invention therefore seeks to combine elements of a social network with a secure club, thereby providing a Network Club (Club).

In this regard, many people, united by certain interests, all too often, do not have time or are embarrassed to initiate communication to fill their life with the events that are interesting for them.

For this purpose a Club Administration function provides support, where required through the support module, and also assists in the arrangement of events to satisfy the requirements of the members for their socialising with the appropriate members having similar interests.

On the basis of this project, the members of the Club shall benefit from the following:—

1. Confidentiality and liability for the disclosure of private correspondence, relating to the members of the Club, both by the Club Administration and the members.

2. Maximum objective approach for the selection of the members for a certain social environment based on their interests.

3. Unlimited socialising with regard to the territorial criterion with the confirmed members.

4. Possibility for the arrangement of meetings, events, official events and any other types of socialising with the member in any part of the world.

5. Possibility for various financial transactions, both between the members and with the help of specially organised associated services offering goods and services, which might be of interest to the members.

6. High level of legal protection from unauthorised use of personal information, accessible internally by the members, including all members of the company staff—network owner. For this purpose, an approved legal document shall be signed by every new member joining the network.

For the implementation of the network the following structure of the Club is proposed:

1.1. Membership only for approved members.

Membership criteria shall be exclusively objective, validated and have standard requirements for all, the compliance with which shall automatically provide membership to any applying individual. No references shall be required.

1.2. Development of a software product, providing for the solution of the assigned tasks, such as providing a suitably protected social network with controlled restricted access.

1.3. Membership cards in the form of an electronic device, which are connected to a computer or any other electronic mechanism allowing for identification of the Club member with a high level of protection. Club member personal information may be stored both on the Club servers and on the individual Club Card, which allows for the possibility to store part of the personal data or all data at the discretion of the Club member. The confirmation that it was the owner of the Club Card who accessed the server, together with the login and the password, could be a fingerprints sensor integrated into the Card, which might be used in the future for financial transactions.

1.4. The synchronisation of the membership Card with the existing payment systems, widely used in the world financial system (VISA, Mastercard, American Express and others).

1.5. Availability of services complying with the interests of the members of the society: buying of watches, yachts, air planes, real estate properties, clothes and accessories, and other categories of goods, which might be of interest to—the members of the society; maintenance of a global database on private jet availability, selling of goods and services directly between the members; technical support for the goods, which might be of interest to the members; arrangement for the fulfillment of the instructions of the Club members in any part of the world with the help of special personal assistants; provision of legal support for all types of transactions; computerised (electronic) and voice service of concierge, systems for booking flights and railway tickets, booking of hotels, etc.

1.6. The provision of a system of points, which will be accrued by the members when purchasing goods and services via associated services, and these points shall be converted in to money after expiration of a certain time. As a result, members will be able to get considerable discounts for purchased goods and services, without violating rights of manufacturers.

1.7. Organisation of various events can be initiated by any Club Member or Club Administration by advertising in the special section of the network. Private only events shall also be possible (organised by a Club Member) initiated by a Member and organised by Club Administration, or initiated and organised by Club Administration.

1.8. Priority service for Club Members in the most popular night clubs, restaurants, hotels, theatres and other places, which might be of interest to the Club Members, on the presentation of the membership card. In particular, access to popular night clubs ahead of queue, priority waiting list to restaurants when no places are available, plus free dessert, special rates in hotels and the possibility for a free upgrade and late checkout, subject to availability in the hotel.

### PREFERRED EMBODIMENT

Currently, the social environments of the wealthy and beautiful dictate that socialising with one another generally occurs by relatively random events. Finding mutual interests is an eternally potentially difficult issue. At the present time, whilst many people possess the attributes and accessories only wealthy people can afford, they are nevertheless not part of a wealthy persons social environment.

Furthermore, it is a problem that the task of getting acquainted and starting communication with beautiful people (mainly females) can be particularly difficult due to their shyness and increased attention to them on the part of all of the opposite sex. However, with the knowledge that certain individuals will have to have a certain financial standing, the level of interest for socialising with them on the part of beautiful and/or famous individuals will significantly increase. An aspect of the Club is therefore to provide an environment of mutual respect between members and equal rights in socialising. It is noted in this respect that beauty or fame is an asset according to many historical examples of unequal marriages and transition of beautiful or famous people into a higher social environment.

In this way, many fears that certain “beautiful” members may harbour due to their apprehension, can be quashed thereby helping to create more serious equal relationships among the Club members. The principle of membership also helps to solve the problem of socialising between married and attached representatives of the social environment, since as opposed to dating sites and open social networks, the socialising in the Club system is based on mutual trust and respect, and in the first place, focussed on exchange of opinions and views.

In connection with this, the following criteria are proposed for acceptance to Club Members:

1. Group No 1.1

Men with capital from 1 Million Dollars.

Women with Capital from 1 Million Dollars

2. Group No 1.2

Women of model appearance

Men of model appearance

3. Group No 1.3

Famous celebrities (politicians, musicians, TV presenters, actors, artists, representatives of show-business, etc.).

Invitation to Group No 1.1 Club membership shall be exercised by a recognised financial institution such as a bank. For this purpose it is proposed to enter into agreements with the banks, who will service private clients for the distribution of this network product exclusively among the clients, whose capital exceeds 1 Million Dollars. The bank may receive a percentage from the amount of the membership fees, and also receive income from the use of the credit cards linked to membership cards. The amount of annual membership fee may be of the order of $10,000 USD.

Invitation to Group No 1.2 Club shall be exercised by recognised model agencies through the models (who are already full Club members), or perhaps though managers, Club supervisors at events, at night clubs, beauty contests and also on the basis of a direct application of the social environment. Such will be interviewed and have a background check. The amount of annual membership fee is $0 USD.

Invitation to Group 1.3 Club shall be exercised through private social network or directly. The amount of annual membership fee is $0 USD.

Club Organisation

The present invention therefore provides a closed, highly specialised social network, where members are categorised into groups and where connectively between members is carefully controlled.

Where connectivity is available members will have certain available Search criteria: namely from surname, name, patronymic name, physical parameters, age, location, photos.

Members may create an event and invite participants. For example, I am a representative of Group No 1.1, male, and I will be in Paris on the 1 of Oct. 2011 on business. As of 7 pm I will be free. I (member of Group No 1.1) create an event: dinner for two in Alan Ducasse restaurant in Paris on 01.10.2011 at 19:30 and invite members of Society No 1.2, 1.3 male or female according to my interests. My advertisement—invitation, appears in the special zone based on location and can be viewed by members having connectivity.

Herewith, the representative of Group 1.1 automatically pays for the event by default, even if it has not been initiated by him, if a special condition has not been included (for example payment 50/50 at the cost of a certain party). Furthermore, upon confirmation of the event, the representative of Group 1.1 shall transfer 1000 points to the account of the representative of Group 1.2 or Group 1.3, 500 points of which shall appear on the account of the member and 500 shall be the commission of the Club.

Subject to agreement of any Club member to accept the invitation to participate in the event, he/she attaches their agreement in a confidential mode, which is not accessible for other members. The event may be of any kind, from a party on a yacht with the admission ticket of 10000 USD to a joint visit to a theatre or transatlantic flight on a private jet or air-liner. The general concept is of friendly socialising without any restrictions or liabilities.

The invention may further encompass management (buying/selling/renting) of expensive properties owned by Club members. This is carried out through a commerce platform module which is linked to the administrator module. Here there will be a restriction that the property must be either owned by the member or his/her company, or there must be a Power of Attorney to sell or rent the property. The indicated documents must be presented to the Club lawyers prior to the event.

For example: I have a private jet and I would like to sell it. I put an advertisement either in the open or confidentially (i.e. without indicating myself as the owner) and invite appropriate club members. Such an advertisement can be placed through the commerce platform module through the administrator module. Thereafter, the negotiations take place with the interested participants in the social network mode. If required, the deal shall be executed by Club lawyers, which can be provided via the support module.

Alternatively, I may have a house in Cap-Ferra and I do not plan to have a holiday there in the period from 01.08.2011 to 31.08.2011. I can therefore prepare an entry in the commerce platform module: house rent in Cap-Ferra in the period from 01.08.2011 to 31.08.2011. Price: 100000 EURO. This advertisement can be placed in a rental section of the commerce platform module: House Rent.

Or, I may be flying on my private jet from Paris to New York on the 20^{th} of Dec. 2011 and on the 24th of December the jet will be used for flying my friends from London to New York. I again can put an entry: Jet available 21st-23rd Dec., 2011, New York-London (Europe). Price: 50000 USD. Or perhaps, I would like to fly on a private jet from New Delhi to Geneva. I can thus prepare an entry: A jet is required from New Delhi to Geneva, 18th-25th Nov. 2011, 50000 USD.

All settlement payments will be processed confidentially by credit cards or bank transfers from one account to another (via Club account) with a deduction of 10% commission by the Club and with the legal support of the Club.

The invention may also encompass the purchase of luxury goods, as described below or for selling of tickets for existing world events. For example, you would like to visit the OSCARS ceremony or Cannes Film Festival, or Monaco Grand Prix. You will be offered in the automatic mode the available options for visiting the events, a list of which shall be accessible in the special section. In the case the event is not included in the list, the member of the Club shall apply to the Club Administration and the requested event shall be arranged.

A Club member may become an initiator of a public event. For example, he/she proposes to the Club Administration to organise a certain event with a large number of invited participants. If the payment for the event is covered by the member, he/she can organise it himself and announce the event in automatic mode or order the event to be organised by Administration by paying the commission in the amount of 20% from the cost of the event in addition to direct expenses, connected with the organisation of this event. In the case, when the cost for the planned event is covered by members of Group 1.1 (go Dutch), the Administration may undertake the management on the event organisation and active search of event participants, willing to pay their part of expenses for the organisation of the event.

The network system may operate a number of associated services.

As an example, there may be a club of connoisseurs of watches of a certain brand.

In this respect, a brand of watches famous all over the world attracts the attention of financially capable part of the population. Many people of this part of the society that already have watches of these brands would like to buy more, some are interested in new models and developments, some require answers to the questions they have. All users of the service have various questions about one brand (type of goods). The following service structure is proposed:

In such a case, the network can for example provide a virtual Club Shop offering the following package of services, which where appropriate would be authorised by the manufacturer as a legal entity:—selling of finished watches; ordering of watches, which are not available for selling, creation of waiting lists, announcement of models under development and processing of preliminary orders, provision of service for watches already in possession with the Club members by courier delivery, possibility for communication for Club members in a form of a chat with the manufacturer on any technical or marketing issues (feedback without intermediary), coverage of all events in the world concerning this brand with photos/videos, arrangement for the invitations for the world events with the participation of manufacturers for the Club members owning watches of a certain price category, organisation of own events by the Club, opportunity for expert evaluation of the price range for pre-owned watches, sale of pre-owned watches to Club members.

The network is intended to have working branches in the countries of the world approved by the manufacturer for execution of logistic operations.

Club members shall moreover enjoy the opportunity of significant discounts for goods and services in the form of points, which shall be converted into the equivalent amounts of money or may be used for purchasing of any other goods on the expiration of a yearly period.

It may be possible to become a member of the Club at the time of buying a new watch or official confirmation of the ownership of the watch of the certain brand. However, if membership is based solely on this basis such members may enjoy a lower priority service compared to full members.

Access is available to all categories of individuals, however of lower service priority as compared with full and real Club members in case of ordering any services. It is not possible to sell a pre-owned watch in one's own name or order services without confirmation of membership.

The invention may also encompass a charity aspect, whereby members can designate a charity of choice and a percentage of any transactions that occur that they are financing is donated to their charity.

It will be understood that the embodiments illustrated above show applications of the invention only for the purposes of illustration. In practice the invention may be applied to many different configurations, the detailed embodiments being straightforward for those skilled in the art to implement.

For example, embodiments of the invention may incorporate a translation module for automatically translating messages and information into different languages (e.g. English, French, Russian, Spanish, Italian, Japanese, Chinese, Korean). This thereby allows communication between different members internationally, allowing them to correspond, network and participate in international events.

Furthermore, embodiments of the invention may also allow communication between club members and other individuals (as well as members of other clubs). This may, for example, enable such individuals to have limited access to certain club services or provide them with an invitation to apply for entry to the club. In some of such embodiments, the following features may be provided:
The ability to register online.
The automatic translation of messages and information.
The possibility of limited access to some club services, on the principle of a lower priority than the club's full members, and without the support of the administration of the club.
Requires a new user to complete a full registration process, including providing their name, mandatory credit card and residential address, and financial correspondence.
If a new user repeats use of the clubs services, the individual may become a partial member of the club and get an ID card, and have the opportunity to enjoy the full club service, including the support of the club's administration, but with a medium priority compared to other users.
An on-line application for membership in a particular club, followed by subsequent consideration by the administration team for compliance with the stated requirements of the individual members.
Ability for new users to communicate with club members only at the initiation of communication coming from a member of the club. The possibility of communication between members of the network is not limited.
   The above features may allow potential new members the opportunity to familiarize themselves with the club and services, prior to their subsequent decision to join the club.

Furthermore, embodiments of the invention may also allow promotion of projects between members. For example, if a member of the club has participated in a charity project, a message, for example a video message regarding that project may be promoted to help attract attention. The message may be circulated to members with an interest in such matters. This can not only help to solve some important social problems, but also helps other members learn about a particular member's philanthropic interests to thereby facilitate networking between members of the club.

Furthermore, embodiments of the invention may also allow for the creation of large events. For example, a member of the club may initiate an event, and offer for the administration of the club to organize it and invite a large number of club members. The administration of the club may then receive a commission (e.g. 20%) in addition to direct costs to the organization.

1. A system configured for hosting a network for facilitating interaction between members of certain socioeconomic and/or interest groups; the system comprising:
a categorising module for categorising individuals according to certain criteria to form a plurality of groups of members, wherein admittance to each group is regulated based on an authority specialising in the specific characteristic of that group;
a governing module for establishing a set of rules governing from which groups members are authorised to interact with one other; and
an administrator module for administrating said rules; said administrator governing connectivity between members in said groups.

2. A system according to claim 1, wherein a first one of said groups is based on its member's financial standing, this criteria being regulated through a recognised financial institution.

3. A system according to claim 1, wherein a second one of said groups is based on physical appearance, this criteria being regulated through a recognised modelling agency.

4. A system according to claim 1, wherein a third one of said groups is based on an interest in a consumer article, this criteria being regulated through a recognised specialist in that article.

5. A system according to claim 4, wherein the article concerned is a horological instrument.

6. A system according to claim 1, further comprising an event diary accessible to members for proposing future events to other members, such events being made available only to certain members according to said set of rules.

7. A system according to claim 6, further comprising a profile module for compiling and storing a profile of each member, the network monitoring member's event proposals and forwarding details of such an event proposal to other members who have both a potential common interest from their profile and who are authorised to have connectivity with said member proposing the event.

8. A system according to claim 1, further comprising a commerce platform module for facilitating rental and/or sale of goods of common interest between members having authorised connectivity.

9. A system according to claim 1, further comprising a support module, said support module comprising a plurality of service providers on stand by for dealing with specific issues raised by said administrator module on behalf of said members.

10. A system according to claim 1, further comprising an access device for obtaining access to the system via a secure identity verification process, involving one or more of finger print analysis, retinal scanning, voice recognition, signature and password submission.

11. A system according to claim 10, wherein said access device comprises an electronic handheld device.

12. A computer-implemented method for providing a network for facilitating interaction between members of certain socioeconomic and/or interest groups; the method comprising:
operating a categorising module for categorising individuals according to certain criteria to form a plurality of groups of members;
operating a governing module for establishing a set of rules governing from which groups, members are authorised to interact with one other, wherein admittance to each group is regulated based on an authority specialising in the characteristic of that group; and
operating an administrator module for administrating said rules, wherein said administrator module is set to govern connectivity between members in said groups according to the set of rules established by the governing module.

13. A method according to claim 12, wherein a first one of said groups is categorised on its member's financial standing, this criteria being regulated through a recognised financial institution.

14. A method according to claim 12, wherein a second one of said groups is categorised on physical appearance, this criteria being regulated through a recognised modelling agency.

15. A method according to claim 12, wherein a third one of said groups is categorised on an interest in a consumer article, this criteria being regulated through a recognised specialist in that article.

16. A method according to claim 12, further comprising a commerce platform module which operates to facilitate rental and/or sale of goods of common interest between members having authorised connectivity.

17. A network system according to claim 1, set up to operate on the Internet.

18. A network system according to claim 1, wherein members are provided with an electronically readable members access card, said card further serving to as a credit or debit card.

19. A computer program for carrying out the method of claim 12.

20. A computer usable medium having control logic stored therein for causing a computer to carry out the method of claim 12.
